(19) United States
(12) Patent Application Publication
(10) Pub. No.: US 2014/0168265 A1
(43) Pub. Date: Jun. 19, 2014

(54) HEAD-UP DISPLAY APPARATUS BASED ON AUGMENTED REALITY

(71) Applicant: Korea Electronics Technology Institute, Seongnam-si (KR)

(72) Inventors: Yang Keun AHN, Seoul (KR); Young Choong PARK, Seoul (KR); Kwang Soon CHOI, Goyang-si (KR); Kwang Mo JUNG, Yongin-si (KR)

(21) Appl. No.: 13/945,048

(22) Filed: Jul. 18, 2013

(30) Foreign Application Priority Data
Dec. 18, 2012 (KR) 10-2012-0148456

(51) Int. Cl. B60R 1/00

(52) U.S. Cl. CPC B60R 1/001
USPC 345/633

(57) ABSTRACT

Disclosed is a head-up display apparatus based on AR that three-dimensionally displays augmented image information on an object external to a vehicle on the basis of actual distance information between the vehicle and the external object, and thus can provide realistic information to a driver. The head-up display apparatus includes a distance information generating unit configured to receive an image signal from an image signal inputting apparatus capturing an image in front of a vehicle and generate distance information on each of a plurality of objects in the front image, an information image generating unit configured to generate an information image of each object in the front image, and an augmentation processing unit configured to generate augmented information image of each object on the basis of the distance information on each object.

### CROSS-REFERENCE TO RELATED APPLICATIONS

This application claims priority under 35 U.S.C. §119 to Korean Patent Application No. 10-2012-0148456, filed on DEC 18, 2012, the disclosure of which is incorporated herein by reference in its entirety.

### TECHNICAL FIELD

The present invention relates to a head-up display apparatus, and more particularly, to a head-up display apparatus that three-dimensionally displays augmented image information on an object external to a vehicle on the basis of actual distance information between the vehicle and the external object, and thus can provide realistic information to a driver.

### BACKGROUND

The demand for display integration for vehicles is increasing all over the world, and many technologies are being researched on a driving safety system of vehicles for vehicle drivers' safety. Especially, a head-up display (HUD) system is an apparatus that enables a driver or a pilot to look at a current state necessary for driving without greatly changing eyes and a focal convergence distance of the eyes, and thus decreases eye fatigue and risks of unexpected accidents caused by moving of the eyes.

Designing of a new interface, which can minimize visual interference to a driver and efficiently transfer various pieces of visual information provided from very many information systems, is a very important issue in practically using intelligent high-safety vehicles. An integrated smart monitor system recently mounted on high-priced vehicles is an advanced vehicle display apparatus that projects information on a current speed, residual fuel, navigation road guide, etc. of a vehicle on a windshield in just front of a driver as a graphics image, and thus minimizes the driver from unnecessarily turning eyes to other position.

The HUD system has a distinctiveness in that the HUD system induces a driver's immediate reaction and provides convenience, compared to other display apparatuses. However, the HUD system researched to date merely outputs information, and has a restriction in realistic expression because a sense of perspective based on a distance to an object is not considered when displaying augmented image information on a screen.

### SUMMARY

Accordingly, the present invention provides a head-up display apparatus that three-dimensionally displays augmented image information on an object external to a vehicle on the basis of actual distance information between the vehicle and the external object.

The present invention also provides a multi-focus head-up display apparatus that traces a vehicle driver's eyes to display augmented image information in a direction of eyes.

The object of the present invention is not limited to the aforesaid, but other objects not described herein will be clearly understood by those skilled in the art from descriptions below.

In one general aspect, a head-up display apparatus based on augmented reality (AR) includes: a distance information generating unit configured to receive an image signal from an image signal inputting apparatus that captures an image in front of a vehicle, and generate distance information on each of a plurality of objects in the front image; an information image generating unit configured to generate an information image of each object in the front image; and an augmentation processing unit configured to generate augmented information image of each object on the basis of the distance information on each object.

The head-up display apparatus may further include: a first information collecting unit configured to collect position information and posture information on the vehicle in real time; and a second information collecting unit configured to collect geographical information and POI information around the vehicle on the basis of current position information and posture information on the vehicle.

The information image generating unit may generate a graphics icon, corresponding to the collected POI information, as the information image.

The information image generating unit may generate the distance information on each object on the basis of at least one of image processing of the received image signal and position coordinate data included in the geographical information.

The augmentation processing unit may decide a position at which the augmented information image of each object is displayed on a windshield of the vehicle, on the basis of the distance information.

The augmentation processing unit may adjust a plurality of depth processing parameters to adaptively perform three-dimensionality processing on the information image of each object on the basis of the distance information, the depth processing parameters including brightness, contrast, sharpness, and size.

The second information collecting unit may collect the geographical information and POI information from an internal database or external server that stores the geographical information and POI information.

The head-up display apparatus may further include a third information collecting unit configured to obtain eyes information on a vehicle driver, wherein the augmentation processing unit decides a position at which the augmented information image of each object is displayed on a windshield of the vehicle, on the basis of the distance information and eyes-tracing information.

Other features and aspects will be apparent from the following detailed description, the drawings, and the claims.

### BRIEF DESCRIPTION OF THE DRAWINGS

FIG. 1 is a system configuration diagram illustrating an external configuration of a head-up display apparatus based on three-dimensional (3D) augmented reality (AR) according to an embodiment of the present invention.

FIG. 2 is a block diagram illustrating an internal configuration of the head-up display apparatus based on 3D AR according to an embodiment of the present invention.

FIG. 3 is an exemplary diagram illustrating an example in which an augmented information image is displayed on a windshield according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

The below-described subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

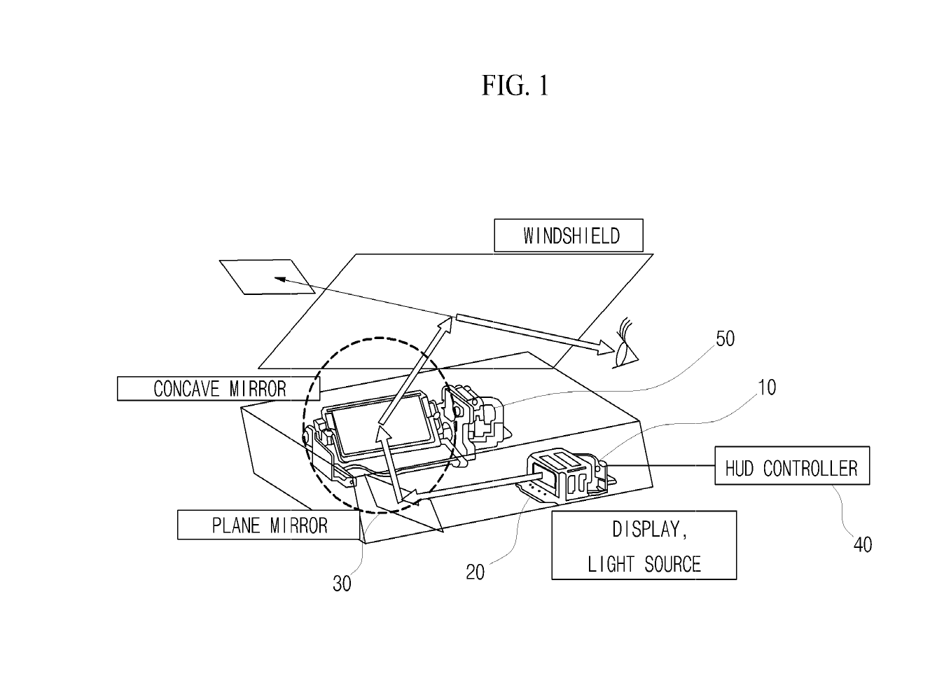

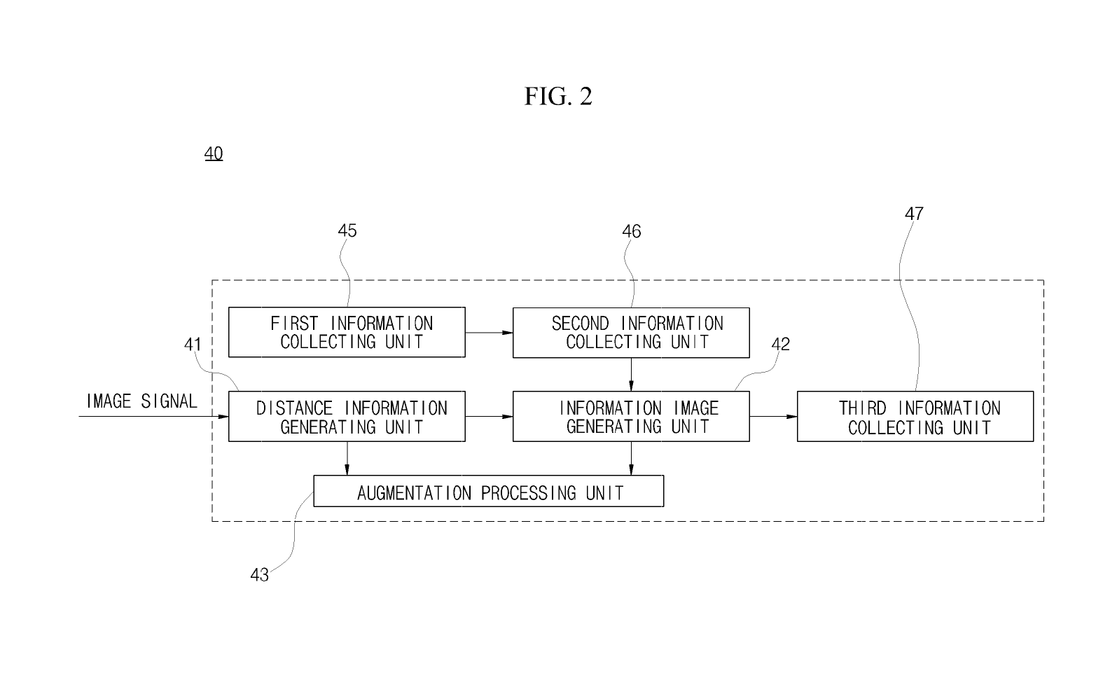

Hereinafter, a head-up display apparatus based on 3D AR according to an embodiment of the present invention will be described in detail with reference to the accompanying drawings. FIG. 1 is a system configuration diagram illustrating an external configuration of a head-up display apparatus based on 3D AR according to an embodiment of the present invention, and FIG. 2 is a block diagram illustrating an internal configuration of an HUD controller in the head-up display apparatus based on 3D AR according to an embodiment of the present invention.

Referring to FIG. 1, the head-up display apparatus based on 3D AR according to an embodiment of the present invention includes a light source 10, an image output unit 20, an optical system 30, an HUD controller 40, and a driver 50.

The light source 10 may use a ultra high pressure (UHP) lamp, a light emitting diode (LED), a laser, or the like. The light source 10 emits light necessary for an operation of the image output unit, and supplies the emitted light to the image output unit 20.

The image output unit 20 generates and outputs a corresponding image on the basis of an image signal and a control signal which are applied from the HUD controller 40. Here, the image signal may is a signal corresponding to running information such as vehicle information, driving information, or the like.

In the embodiment, the image output unit 20 uses a liquid crystal display (LCD), but is not limited thereto. As another example, the image output unit 20 may use a thin film display device such as a plasma display panel (PDP), an organic light emitting display (OLED), or the like. Also, when the image output unit 20 is a reflective LCD, the light source 10 is not needed.

The optical system 30 includes a plurality of lenses, and changes a light path to output light such that an image outputted from the image output unit 20 is projected on a windshield of a vehicle, thereby transmitting the image outputted from the image output unit 20. At this time, the optical system 30 may appropriately adjust a focal distance, size, etc. of an image outputted from the image output unit 20. The optical system 30, as illustrated in FIG. 1, may include a plane minor and a concave mirror.

The HUD controller 40 generates distance information on a current position of a vehicle about objects (for example, main buildings around a road such as a hospital, a university, etc.) disposed in a front direction of a driving vehicle on the basis of an image signal corresponding to a captured image in front of the vehicle and/or geographical information and point of interest (POI) information on a periphery of the vehicle.

For example, the HUD controller 40 may process the image signal corresponding to the captured image in front of the vehicle to generate distance information on each of the objects in the front image. To this end, an image processing technique is needed, and may use various techniques, which generate depth information on an object in a two-dimensional (2D) image or a 3D image, such as a method using one depth camera, a depth information generating method using a focus in a single frame image, a method using a multi-perspective camera, a method using both the multi-perspective camera and the depth camera, etc.

As another example, the HUD controller 40 may generate distance information on each object in front of the vehicle on the basis of geographical information and POI information which are obtained on the basis of current position information and posture information on the vehicle.

As another example, the HUD controller 40 may generate distance information on each object by all using the image processing of the captured front image and the geographical information and POI information.

Moreover, the HUD controller 40 generates an information image of each object in the front image, and decides a position at which the information image is displayed on the windshield of the vehicle, on the basis of the distance information on each object.

Moreover, on the basis of eyes-tracing information captured by a camera installed inside the vehicle, the HUD controller 40 may appropriately adjust a focal distance and size of the information image such that an information image based on a direction of eyes is outputted to the windshield of the vehicle, or generate control information used to change a position at which the information image is displayed and transfer the control information to the driver 50.

An internal configuration of the HUD controller 40 performing the above-described function is as illustrated in FIG. 2.

Referring to FIG. 2, in the embodiment, the HUD controller 40 includes a distance information generating unit 41, an information image generating unit 42, and an augmentation processing unit 43.

In an embodiment, the distance information generating unit 41 receives an image signal from an image signal inputting apparatus that captures an image in front of a vehicle, and generates distance information on each object in the front image by using an image processing technique.

Alternatively, the distance information generating unit 41 may generate distance information by using radar or lidar (light detection and ranging) sensing technology, or generate distance information by using a scheme with the image processing technique and radar or lidar sensing technology integrated thereinto.

The distance information on each object in the front image may be obtained as relative depth information between the vehicle and front each object at a time where the image is captured, in a 3D coordinate space that includes the vehicle and each object in the front image. Alternatively, scaling information that denotes a ratio of the depth information and an actual distance may be obtained together with the distance information.

In another embodiment, the distance information generating unit 41 may generate distance information on each object in front of the vehicle on the basis of geographical information and POI information which are obtained on the basis of current position information and posture information on the vehicle.

Alternatively, the distance information generating unit 41 may generate the distance information on each object by all using the image processing of the captured front image, the radar or lidar sensing technology, and the geographical information and POI information.

A means for obtaining position information and posture information on the vehicle is needed for using the position information and posture information when the distance information generating unit 41 generates the distance information between each object and the vehicle. To this end, the HUD controller 40 according to an embodiment of the present invention may further include a first information collecting unit 45 that collects the position information and posture information on the vehicle in real time, and a second information collecting unit 46 that collects the geographical information and POI information around the vehicle on the basis of the current position information and posture information on the vehicle.

In an embodiment, the first information collecting unit 45 may receive the position information from a global positioning system (GPS) satellite through a position information module installed in the vehicle. Also, the first information collecting unit 45 may obtain the posture information on the vehicle by using an electronic compass and an acceleration sensor.

The second information collecting unit 45 collects the geographical information and POI information corresponding to the current position information and posture information on the vehicle from a database that stores geographical information data and POI information data. Here, the database may be built in an internal memory of the HUD controller 40, or the second information collecting unit 45 may collect the geographical information and POI information through a wireless communication scheme from a database built in an external server.

The wireless communication scheme used for obtaining the information from the external server may use mobile communication, wireless Internet communication, short range communication, or the like, but the embodiment is not limited to any one communication scheme.

For example, the mobile communication may transmit and receive a radio signal from and to at least one of a base station, an external terminal, and a server over a mobile communication network. The radio signal may include various types of data based on transmission and reception of a voice call signal, a video call signal, or a letter/multimedia message.

The wireless Internet communication denotes wireless Internet access, and may use wireless local area network (WLAN), Wi-Fi, wireless broadband (Wibro), world interoperability for microwave access (Wimax), high speed downlink packet access (HSDPA), or the like.

The short range communication technology may use Bluetooth, radio frequency identification (RFID), infrared data association (IrDA), ultra wideband (UWB), ZigBee, or the like.

The information image generating unit 42 generates the information image of each object in front of the vehicle. Here, the information image denotes information on what an object in front of the vehicle is.

Here, the object in front of the vehicle may be defined in the following method.

1. Read an external object candidate group disposed in front of a vehicle from geographical information and POI information around the vehicle on the basis of current position information and posture information on the vehicle, and extract an object within an average viewing angle range of a driver from the object candidate group

2. Extract an object in an information image captured by an image collecting apparatus.

The information image generating unit 42 may generate the information image, extracted by the above-described method, as a graphics icon corresponding to the POI information. In an embodiment, the POI information and the information image (for example, graphics icon) may be pre-stored as a set in the HUD controller 40 or an external database.

At this time, the information image generating unit 42 reads POI information and information image of the object, extracted by the above-described method, from the database.

The augmentation processing unit 43 performs augmentation processing on the information image of each object to give three-dimensionality to the information image on the basis of the distance information on each object.

In an embodiment, the augmentation processing unit 43 performs depth-augmentation processing on the information image of each object on the basis of the distance information. That is, the augmentation processing unit 43 brightly processes an object within a short distance to enhance three-dimensionality. Preferably, the augmentation processing unit 43 may perform augmentation processing including brightness processing, sharpness processing, contrast processing, etc.

Specifically, the augmentation processing unit 43 selects the optimal depth-augmentation processing technique, for example, brightness processing, contrast processing, sharpness processing, memorized-color processing, size processing, or the like, or selects a combination thereof to perform the selected augmentation processing according to depth information. Also, the augmentation processing unit 43 may adjust a depth processing parameter to adaptively perform three-dimensionality processing on the information image according to distance information.

For example, when brightness processing is performed, the augmentation processing unit 43 may brightly process a portion having a sense of low depth, namely, an object within a short distance, to effect three-dimensionality augmentation processing, and select an effect, such as fog and blur, as a three-dimensionality processing variable as to a long-distance portion.

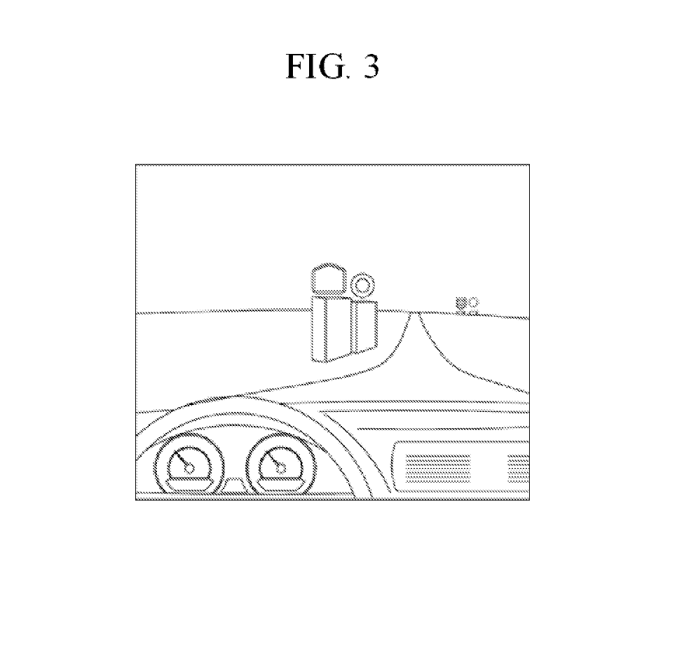

The augmentation processing unit 43 may differentially process a size of the information image, in addition to the above-described brightness, to effect three-dimensionality augmentation processing. FIG. 3 is an exemplary diagram illustrating an example in which an augmented information image is displayed on the windshield according to an embodiment of the present invention.

In FIG. 3, an augmented information image of each object may be considered as being displayed on a corresponding position. As illustrated in FIG. 3, the head-up display apparatus based on 3D AR according to the present invention differentially displays the size of the information image according to a current distance from the vehicle, thereby enabling the driver to naturally feel three-dimensionality.

The HUD controller 40 according to an embodiment of the present invention may further include a third information collecting unit 47 for obtaining eyes information on the vehicle driver.

The third information collecting unit 47 receives driver's eyes-tracing information transferred from the camera installed in the vehicle. At this time, the augmentation processing unit 43 decides a position at which the augmented information image of each object is displayed on the windshield of the vehicle, on the basis of at least one of the distance information and the eyes-tracing information.

In an embodiment, the augmentation processing unit 43 may decide a position at which the augmented information image is displayed, by using only the distance information on each object, and perform an operation of changing a predetermined display position by using the eyes-tracing information.

In an another embodiment, the augmentation processing unit 43 may decide a position at which the augmented information image is displayed from the beginning, by simultaneously using the eyes-tracing information and the distance information on each object.

According to the present invention, as described above, image information augmented into a 3D image is three-dimensionally displayed based on actual distance information, thereby providing realistic information to a driver.

Moreover, the head-up display apparatus gives a sense of perspective to image information to be augmented by tracing eyes, and increases an accuracy of a displayed position, thus transferring realistic information.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A head-up display apparatus based on augmented reality (AR), comprising:
a distance information generating unit configured to receive an image signal from an image signal inputting apparatus that captures an image in front of a vehicle, and generate distance information on each of a plurality of objects in the front image;
an information image generating unit configured to generate an information image of each object in the front image; and
an augmentation processing unit configured to generate augmented information image of each object on the basis of the distance information on each object.

2. The head-up display apparatus of claim 1, further comprising:
a first information collecting unit configured to collect position information and posture information on the vehicle in real time; and
a second information collecting unit configured to collect geographical information and POI information around the vehicle on the basis of current position information and posture information on the vehicle.

3. The head-up display apparatus of claim 2, wherein the information image generating unit generates a graphics icon, corresponding to the collected POI information, as the information image.

4. The head-up display apparatus of claim 2, wherein the information image generating unit generates the distance information on each object on the basis of at least one of image processing of the received image signal and position coordinate data comprised in the geographical information.

5. The head-up display apparatus of claim 1, wherein the augmentation processing unit decides a position at which the augmented information image of each object is displayed on a windshield of the vehicle, on the basis of the distance information.

6. The head-up display apparatus of claim 1, wherein the augmentation processing unit adjusts a plurality of depth processing parameters to adaptively perform three-dimensionality processing on the information image of each object on the basis of the distance information, the depth processing parameters comprising brightness, contrast, sharpness, and size.

7. The head-up display apparatus of claim 2, wherein the second information collecting unit collects the geographical information and POI information from an internal database or external server that stores the geographical information and POI information.

8. The head-up display apparatus of claim 1, further comprising a third information collecting unit configured to obtain eyes information on a vehicle driver,
wherein the augmentation processing unit decides a position at which the augmented information image of each object is displayed on a windshield of the vehicle, on the basis of the distance information and eyes-tracing information.

9. A head-up display apparatus based on augmented reality (AR), comprising:
a geographical information database configured to store 3D geographical information data;
a distance information generating unit configured to generate distance information between an object and a current position of a vehicle by using the geographical information database, the object being disposed in a front direction of the vehicle which is driving; and
an information image generating unit configured to generate information image on information on the object or path information on the basis of the distance information, the information image being differentially displayed in size on the basis of the distance information between the object and the current position of the vehicle.

10. The head-up display apparatus of claim 9, wherein the distance information generating unit generates distance information on a plurality of objects disposed in the front direction by further using at least one of image information on a captured image in front of the vehicle and a distance measuring sensor such as a radar or a lidar.
